(19) United States
(12) Patent Application Publication
(10) Pub. No.: US 2013/0161026 A1
(43) Pub. Date: Jun. 27, 2013

(54) CHEMICAL GLASS TRANSITION TEMPERATURE REDUCER

(71) Applicants: Ramon R. Garza, Pearland, TX (US); John C. Welch, Spring, TX (US); Vu Thieu, Houston, TX (US)

(72) Inventors: Ramon R. Garza, Pearland, TX (US); John C. Welch, Spring, TX (US); Vu Thieu, Houston, TX (US)

(73) Assignee: BAKER HUGHES INCORPORATED, Houston, TX (US)

(21) Appl. No.: 13/334,394

(22) Filed: Dec. 22, 2011

(51) Int. Cl. C09K 8/00; E21B 23/00

(52) U.S. Cl. 166/381; 507/219

(57) ABSTRACT

A method for deploying a shape memory polymer includes disposing a shape memory polymer having a deformed shape in an environment at a first temperature, the shape memory polymer having a first glass transition temperature which is greater than the first temperature. The method also includes decreasing the glass transition temperature of shape memory polymer from the first glass transition temperature to a second glass transition temperature which is less than or equal to the first temperature; and expanding the shape memory polymer to deploy the shape memory polymer in a deployed shape.

### BACKGROUND

Shape memory polymers (SMPs) are polymers which regain their original shape when heated above their glass transition temperature (Tg). Articles are formed from shape memory polymer by first heating above the glass transition temperature and then shaping the polymer, then subsequently fixing the shape by cooling to below the glass transition temperature. During deployment, the shaped article is heated above the glass transition temperature to allow recovery of the first molded shape.

A variety of shape memory polymers (SMPs) have been used in numerous areas. In particular, SMPs have been used in downhole environments (e.g., oil and natural gas production) as sealing members and filters. However, deployment of the SMP has involved thermal activation. In thermal activation, the temperature of the SMP is increased above the glass transition temperature (Tg) of the SMP to recover its original shape. As a thermal activation medium, heated downhole fluids are used to increase the temperature of the SMP to greater than its Tg.

Alternatives to thermal activation of SMP articles downhole would be well-received in the art.

### BRIEF DESCRIPTION

In an embodiment, a method for deploying a shape memory polymer, comprising: disposing a shape memory polymer having a deformed shape in an environment at a first temperature, the shape memory polymer having a first glass transition temperature which is greater than the first temperature; decreasing the glass transition temperature of shape memory polymer from the first glass transition temperature to a second glass transition temperature which is less than or equal to the first temperature; and expanding the shape memory polymer to deploy the shape memory polymer in a deployed shape.

In another embodiment, a method for deploying a shape memory polymer in a downhole environment comprises disposing a shape memory polymer having a deformed shape in the downhole environment which is at a first temperature; contacting the shape memory polymer with an activation fluid to decrease the glass transition temperature of the shape memory polymer below the first temperature; expanding the shape memory polymer to a deployed shape; and introducing a non-activation fluid to increase the glass transition temperature to greater than the first temperature and to maintain the shape memory polymer in the deployed shape.

In another embodiment, a system for deploying a shape memory polymer comprises an activation fluid comprising a brine, solvent, and alcohol; and a shape memory polymer which is deployed by a decrease in its glass transition temperature in response to contact with the activation fluid.

### BRIEF DESCRIPTION OF THE DRAWINGS

The following descriptions should not be considered limiting in any way. With reference to the accompanying drawings, like elements are numbered alike:

FIG. 1 is a graph showing glass transition temperature variation over time for a shape memory polymer;

FIG. 2 is a graph showing a diameter size change of a shape memory polymer with respect to a change in its glass transition temperature;

FIG. 3 is a graph of size versus time for a shape memory polymer in contact with an activation fluid at 105° F. (40.5° C.);

FIG. 4 is a graph of size versus time for a shape memory polymer in contact with an activation fluid at 110° F. (43.3° C.); and

FIG. 5 is a graph of size versus time for a shape memory polymer in contact with an activation fluid at 115° F. (46.1° C.).

### DETAILED DESCRIPTION

A detailed description of one or more embodiments is presented herein by way of exemplification and not limitation with reference to the Figures.

It has been discovered that a shape memory polymer can be deployed (without increasing the temperature of its environment) by decreasing the glass transition temperature (Tg) of the shape memory polymer below the environment's temperature. In this manner, rapid and selective deployment of a downhole article that includes a shape memory polymer occurs by contact of such an article with an activation fluid to lower the Tg of the downhole article below the surrounding downhole temperature.

In an embodiment, a shape memory polymer is deployed from a deformed shape to an original shape by shape memory recovery due to contacting the shape memory polymer with an activation fluid that lowers the Tg of the shape memory polymer.

According to an embodiment, a shape memory polymer includes a base polymer, for example polyurethane. The shape memory polymer can be an open cell foam or a solid, where the polymer is polyurethane. Unlike the open cell foam, the solid is substantially void-free and/or substantially devoid of interconnected structures that allow fluid communication through the solid. Polyurethane in general is a condensation product of a di- or polyisocyanate and a di- or polyhydroxy compound (also referred to as diol or polyol herein). A chain extender (e.g., chain extenders based on di- or polyamines), alternatively or in addition to diols, can be included in place of part of the diol charge to form the polyurethane. The diol, polyol, diisocyanate, polyisocyante, chain extender, and other compounds that react to form the polyurethane are referred to collectively as reactive monomers.

Di- and polyhydroxy compounds can include, for example, diols and polyols having from 2 to 30 carbon atoms. Useful diols include glycols including oligomeric glycols having repeating alkyleneoxy units including di-, tri- and higher glycols, or polyglycols. Exemplary diols may include ethylene glycol, propylene glycol, trimethylene glycol, 1,3-butanediol, 1,4-butanediol, bishydroxymethyl cyclohexane, neopentylglycol, diethylene glycol, hexanediol, dipropylene glycol, tripropylene glycol, polypropylene glycol, triethylene glycol, polyethylene glycol, tetraethylene glycol, oligomeric and polymeric glycols such as polyethylene glycols, polypropylene glycols, polybutylene glycols, poly(ethylene-propylene) glycols, and the like. Combinations comprising at least one of the foregoing dihydroxy compounds can be used.

Exemplary suitable polyols include triols, for example glycerol, trimethylol propane, pentaerythritol, tris(2-hydroxyethyl) isocyanurate, and the like; tetrols such as dipentaerythritol; and other sugar alcohols such as inositol, myoinositol, sorbitol, and the like. Combinations comprising at least one of the foregoing polyhydroxy compounds can be used.

Polyurethanes are typically prepared by the condensation of a diisocyanate with a diol. Aliphatic polyurethanes having at least two urethane moieties per repeating unit are useful, wherein the diisocyanate and diol used to prepare the polyurethane comprise divalent aliphatic groups that may be the same or different. The divalent aliphatic units can be C2 to C30, specifically C3 to C25, more specifically C4 to C20 alkylene groups, including straight chain alkylene, branched chain alkylene, cycloalkylene, heteroalkylene such as oxyalkylene (including polyetheralkylene), and the like. Exemplary aliphatic diradical groups include but are not limited to ethylene; 1,2- and 1,3-propylene; 1,2-, 1,3-, and 1,4-butylene; 1,5-pentamethylene; 1,3-(2,2-dimethyl)propylene; 1,6-hexamethylene; 1,8-octamethylene; 1,5-(2,2,4-trimethyl)pentylene, 1,9-nonamethylene; 1,6-(2,2,4-trimethyl)hexylene; 1,2-, 1,3-, and 1,4-cyclohexylene; 1,4-dimethylene cyclohexane; 1,11-undecamethylene; 1,12-dodecamethylene, and the like.

Monomeric diisocyanates may be used to prepare the polyurethane. The diisocyanate component may be a monomeric C4-20 aliphatic or C4-20 aromatic diisocyanate. Exemplary aliphatic diisocyanates include isophorone diisocyanate; dicyclohexylmethane-4,4′-diisocyanate; 1,4-tetramethylene diisocyanate; 1,5-pentamethylene diisocyanate; 1,6-hexamethylene diisocyanate; 1,7-heptamethylene diisocyanate; 1,8-octamethylene diisocyanate; 1,9-nonamethylene diisocyanate; 1,10-decamethylene diisocyanate; 2,2,4-trimethyl-1,5-pentamethylene diisocyanate; 2,2′-dimethyl-1,5-pentamethylene diisocyanate; 3-methoxy-1,6-hexamethylene diisocyanate; 3-butoxy-1,6-hexamethylene diisocyanate; ω,ω′-dipropylether diisocyanate; 1,4-cyclohexyl diisocyanate; 1,3 -cyclohexyl diisocyanate; trimethylhexamethylene diisocyanate; and combinations comprising at least one of the foregoing.

Exemplary aromatic polyisocyanates include toluene diisocyanate, methylene bis-phenylisocyanate (diphenylmethane diisocyanate), methylene bis-cyclohexylisocyanate (hydrogenated MDI), naphthalene diisocyanate, and the like.

Polymeric or oligomeric diisocyanates can also or alternatively be used to prepare a polyurethane or a urethane- or urea-linked copolymer. Exemplary oligomeric or polymeric chains for the polymeric diisocyanates include polyurethanes, polyethers, polyester, polycarbonate, polyestercarbonates, and the like. In an embodiment, the polyisocyanate is a polymeric polyisocyanate, such as a polymer chain with terminal isocyanate groups. Useful polyisocyanates include those based on polyesters such as polyaliphatic esters including polylactones, polyarylate esters including copolymers of phthalates with phenols such as bisphenol A, dihydroxybenzenes, and the like; and poly(aliphatic-aromatic)esters such as ethylene terephthalate, butylene terephthalate, and the like.

A useful class of polyaliphatic ester-based diisocyanates is based on polylactones such as polybutyrolactones, polycaprolactones, and the like. Exemplary polyester-diisocyanates based on these polyesters include ADIPRENE® LFP 2950A and PP 1096, available from Chemtura, which are p-phenylene diisocyanate (PPDI)-terminated polycaprolactone prepolymers.

Alternatively or in addition to a dihydroxy compound, the diisocyanate may be condensed with a diamine, sometimes referred to as a chain extender. It will be appreciated that condensation of a diisocyanate with a dihydroxy compound produces a urethane linkage in the polymer backbone, whereas the condensation of diisocyanate with the diamine produces a urea linkage in the polymer backbone. Exemplary chain extenders include C4-30 diamines. The diamines may be aliphatic or aromatic. In a specific embodiment, useful diamines include aromatic diamines such as, for example, 4,4′-bis(aminophenyl)methane, 3,3′-dichloro-4,4′-diaminodiphenyl methane (also referred to as 4,4′-methylene-bis(o-chloroaniline), abbreviated MOCA), dimethylsulfidetoluene diamine (DADMT), and the like.

In an embodiment, an open cell foam having a base polymer of polyurethane is formed by combining, for example, a diisocyanate and diol described herein. A blowing agent can be included to produce the pores for the open cell foam. According to an embodiment, a blowing agent such as water is included with the diol to provide a foam structure due to generation of carbon dioxide from the reaction between diisocyanate and water when the diisocyanate is combined with the water and diol. Alternatively the foam can be formed by other chemical or physical blowing agents. Examples of the blowing agent include hydrochlrorofluorocarbons (e.g., methylene chloride, tetrafluoroethylene, pentafluoropropane, heptafluoropropane, pentafluorobutane, hexafluorobutane, and dichloromonofluoroethane), hydrocarbons (for example, pentane, isopentane, and cyclopentane), carbon dioxide, acetone, and water

In a further embodiment, the pores for the open cell foam can be produced by placing the above components in a vacuum chamber and decreasing the pressure below the internal pressure of the forming polyurethane to cause out-gassing of the polymer material.

The density of the foam can be controlled by the amount of water or blowing agent added. The amount of water can be about 0.5 weight percent (wt %) to about 5.0 wt %, specifically about 0.5 wt % to about 4.0 wt %, and more specifically about 0.5 wt % to about 3.0 wt %, based on the weight of the diol (or polyol). Alternatively or additionally, physical blowing agents can be used in amount about 0.5 wt % to about 15 wt %, and specifically about 0.5 wt % to about 10 wt %, based on the combined weight of the diol (or polyol) and diisocyanate (or polyisocyanate). In an embodiment, physical blowing agents, such as carbon dioxide, can be used in combination with water as a blowing agent.

According to an embodiment, the composition containing the reactive monomers are mixed for a time (e.g., about 20 seconds) and then disposed in a mold, which is immediately closed by placing a top metal plate on the mold. Due to the significant amount of pressure generated by the foam-forming process, a clamp can be used to hold the top metal plate and mold together to prevent leakage of the foam material from the mold. After about 2 hours, the polyurethane foam material is sufficiently cured such that it can be removed from the mold, i.e., de-molded. Before de-molding, the mold is cooled below the glass transition temperature of the polymer to fix the shape. Thereafter, in one specific embodiment, the polyurethane foam material is post-cure treated at a temperature of about 100° C. for about 6 hours so that the polyurethane foam material reaches its full strength. Once de-molded, the material is a shape memory polymer in an original shape.

The polyurethane foam material may have a layer of “skin” on the outside surface of the polyurethane. The skin is a layer of solid polyurethane formed when the mixture containing reactive monomers contacts the mold surface. The thickness of the skin can depend on the concentration of water added to the mixture. Excess water content decreases the thickness of the skin, and insufficient water content increases the thickness of the skin. The formation of the skin is believed to be due to the reaction between the isocyanate in the mixture and the moisture on the mold surface. Therefore, additional mechanical conversion processes can be used to remove the skin. Tools such as band saws, miter saws, hack saws, and hot filament wire saws can be used to remove the skin. After removing the skin from the polyurethane foam material, it will have a full open cell structure, excellent elasticity, and very good tear strength. In the case where the polyurethane has an outer skin that needs to be removed, the mold can be sufficiently sized to take into account material loss due to removal of the skin.

As an alternative, to the open cell foam, the polyurethane is a solid without the interconnecting pores characteristic of an open cell foam. Here, for example, the reactive monomers are combined without addition of a blowing agent, and the components are molded and then de-molded as described above to produce a shape memory polymer in an original shape that is solid.

The shape memory polymer after de-molding has not only an original shape but a glass transition temperature (Tg), which is a physical characteristic of the material. According to an embodiment, once the polyurethane shape memory polymer has been de-molded in its original shape, the shape memory polymer can be heated to a temperature greater than or close to its Tg and a deformation stress can be applied to the shape memory polymer to reshape the shape memory polymer into a deformed shape. The shape memory polymer is then cooled below its Tg with the deformation stress still applied to the shape memory polymer. Upon cooling below the Tg of the shape memory polymer, the shape memory polymer is fixed in the deformed shape even with removal of the deformation stress. To return to the original shape, the shape memory polymer is again heated to a temperature greater than or close to its Tg.

Alternative to heating the shape memory polymer for shape recovery, a method for deploying the shape memory polymer includes disposing a shape memory polymer having a deformed shape in an environment at a first temperature (the shape memory polymer has a first glass transition temperature which is greater than the first temperature); decreasing the glass transition temperature of shape memory polymer from the first glass transition temperature to a second glass transition temperature that is less than or equal to the first temperature; and expanding the shape memory polymer to deploy the shape memory polymer in a deployed shape. In a non-limiting embodiment, the shape memory polymer is polyurethane. Further, the shape memory polymer can be an open cell foam or a solid. Decreasing the glass transition temperature of the shape memory polymer includes contacting the shape memory polymer with an activation fluid.

The glass transition temperature is a physical property of the shape memory polymer and depends in part on the interaction of the component polyurethane chains. Strong interactions among the polyurethane polymer chains lead to a greater glass transition temperature. In contrast, weaker interactions among the polyurethane polymer chains produce a smaller value for the glass transition temperature. It should be recognized that the aggregate strength of the interactions provides the glass transition temperature of the polyurethane. Thus, selection of the reactive monomers influences the glass transition temperature since the reactive monomers become part of the polymer matrix. The glass transition temperature of the polyurethane is about 90° C. to about 170° C., specifically about 95° C. to about 160° C., and more specifically about 100° C. to about 150° C. As will be discussed, the glass transition temperature of the polyurethane can be decreased by contact with the activation fluid so that the transition glass temperature decreases by about 5° C. to about 70° C. The depression of the glass transition temperature may be temporary and last for as long as the activation fluid is present among the polyurethane chains. Further, as should be appreciated, a shape memory polymer made of polyurethane will have substantially the same glass temperature and decreased glass temperature as the polyurethane.

According to an embodiment, the shape memory polymer is contacted with an activation fluid to lower the glass transition temperature of the shape memory polymer. The activation fluid includes brine, solvent, and alcohol. Additionally, the activation fluid can include a surfactant.

Brine can be included in the foregoing compositions to modify the density of the activation fluid as well as moderate the diffusion rate of the activation fluid in the shape memory polymer. The brine can be, for example, seawater, produced water, completion brine, or a combination thereof The properties of the brine can depend on the identity and components of the brine. Seawater, as an example, contains numerous constituents such as sulfate, bromine, and trace metals, in addition to halide-containing salts. On the other hand, produced water can be water extracted from a production reservoir (e.g., hydrocarbon reservoir), produced from the ground. Produced water is also referred to as reservoir brine and often contains many components such as barium, strontium, and heavy metals as well as halide salts. In addition to the naturally occurring brines (seawater and produced water), completion brine can be synthesized from fresh water by addition of various salts such as NaCl, CaCl₂, or KCl to increase the density of the brine to a value such as 10.6 pounds per gallon of CaCl₂ brine. Completion brines can provide a hydrostatic pressure optimized to counter the reservoir pressure downhole. The above brines can be modified to include an additional salt. In an embodiment, the additional salt included in the brine is NaCl, KCl, NaBr, MgCl₂, CaCl₂, CaBr₂, ZnBr₂, NH₄Cl, sodium formate, potassium formate, cesium formate, and the like. The salt can be present in the brine in an amount from about 0.5 wt. % to about 50 wt. %, specifically about 1 wt. % to about 40 wt. %, and more specifically about 1 wt. % to about 25 wt. %, based on the weight of the brine.

In addition to brine, the activation fluid also contains solvent, which is also referred to as a mutual solvent because the solvent is miscible with more than one class of liquids. In particular, a mutual solvent can be soluble in hydrophobic and hydrophilic liquids, for example, hydrocarbon fluids and aqueous solutions. Suitable mutual solvents include but are not limited to substituted and unsubstituted glycols of the formula R¹O(CH₂CHR²O)ₙR³, wherein R¹, R², and R³ are independently hydrogen, alkyl group, aryl group, and acetyl group, and n is about 1 to about 10. In an embodiment, the alkyl group, aryl group, and acetyl group have 1 to about 6 carbon atoms, specifically 1 to about 4 carbon atoms; and more specifically 1 to about 2 carbon atoms; n is 1 to about 10, specifically 1 to about 6, and more specifically 1 to about 3.

Examples of substituted and unsubstituted glycols include glycols such as ethylene glycol, propylene glycol, butylene glycol, hexylene glycol, di-propylene glycol, diethylene glycol, tripropylene glycol, triethylene glycol, and poly glycols; glycol ethers such as ethylene glycol monomethyl ether (EGMME), ethylene glycol monoethyl ether (EGMEE), ethylene glycol monopropyl ether (EGMPE), ethylene glycol monoisopropyl ether, ethylene glycol monobutyl ether (EGMBE), ethylene glycol monophenyl ether, ethylene glycol monobenzyl ether, diethylene glycol monomethyl ether (DEGMME), diethylene glycol monoethyl ether (DEGMEE), diethylene glycol mono-n-butyl ether (DEGMBE), and dipropylene glycol monomethyl ether (DPGMEE); dialkyl ethers such as ethylene glycol dimethyl ether (EGDME), ethylene glycol diethyl ether (EGDEE), and ethylene glycol dibutyl ether (EGDBE); and esters such as ethylene glycol methyl ether acetate (EGMEA), ethylene glycol monethyl ether acetate (EGMEEA), and ethylene glycol monobutyl ether acetate (EGMBEA). Combination comprising at least one of the foregoing can be used.

In an embodiment, the solvent is a glycol ether wherein R¹ and R² are both hydrogen; R³ is an alkyl group including methyl, ethyl, propyl, isopropyl, and butyl groups; and n is 1. In another embodiment, the solvent is specifically ethylene glycol monomethyl ether (EGMME), and more specifically ethylene glycol monobutyl ether (EGMBE). Such solvents are available from, for example, Union Carbide Corporation.

Other suitable solvents include amides of the formula R⁴CONR⁵R⁶, wherein R⁴, R⁵, and R⁶ are independently a C1-C5 alkyl group or C1-C5 alkenyl group, and any two of R⁴-R⁶ can cyclize together to form a cycle as in 1-methyl-2-pyrrolidinone. Examples of amide solvents include but are not limited to N,N-dimethylformamide, N,N-diethylformamide, N,N-dimethylacetamide, N,N-diethylacetamide, N,N-dimethylpropionamide, N,N-dimethylbutyramide, 1-methyl-2-pyrrolidinone, and 1-ethyl-2-pyrrolidinone. Such amides are commercially available from, for example, Sigma-Aldrich.

The solvent is not particularly limited and can be any one or a combination comprising at least one of the foregoing solvents as long as the alcohol and brine are miscible therein to an appreciable extent.

The activation fluid also contains an alcohol. The alcohol can be linear or branched. In an embodiment the alcohol is a C1-C10 alcohol, including monohydric and polyhdric alcohols. Examples of the monohydric alcohol include methanol, ethanol, n-propanol, isopropanol, n-butanol, 2-butanol, isobutanol, tert-butanol, n-pentanol, isopentanol, 2-pentanol, hexanol, octanol, isooctanol, cyclohexanol. 2-methyl-1-butanol, 2-methyl-1-pentanol, 3-methyl-2-butanol, 2-ethylhexanol. Other alcohols include polyhydric alcohols such as diols, triols, and polyols, including ethylene glycol, propylene glycol, 1,3-propanediol, 1,4-butanediol, 1,2,4-butanetriol, glycerin, erythritol, and the like. Combinations of the foregoing can be used.

The amount of the brine, solvent, and alcohol in the activation fluid depends on the conditions and characteristics of the downhole environment as well as the desired amount and/or rate of expansion of the shape memory polymer. The alcohol can be present in the activation fluid in an amount of about 2 weight percent (wt %) to about 98 wt %, specifically about 10 wt % to about 90 wt %, and more specifically about 30 wt % to about 70 wt %, based on the weight of the activation fluid. The solvent can be present in the composition in an amount from about 0.05 wt. % to about 90 wt. %, specifically about 0.1 wt. % to about 50 wt. %, and more specifically about 1 wt. % to about 20 wt. %, based on the weight of the activation fluid. The brine can be present in the activation fluid in an amount of about 20 wt % to about 99 wt %, specifically about 30 wt % to about 90 wt %, and more specifically about 40 wt % to about 80 wt %, based on the weight of the activation fluid.

According to a non-limiting embodiment, the solvent is different than the alcohol in the activation fluid. In another embodiment, the solvent and the alcohol are the same in the activation fluid. In a specific embodiment, the activation fluid includes brine, EGMBE, and methanol. More particularly, the activation fluid contains about 50 volume percent (vol %) to about 99 vol % brine, about 1 vol % to about 50 vol % EGMBE, and about 1 vol % to about 25 vol % methanol, based on the density of the activation fluid.

The brine, solvent, and alcohol can be combined together as a composition, or the individual components can be used separately as the activation fluid. Alternatively, two of the components can be combined while the third is combined to the two-component composition at a later time, such as upon introduction of the activation fluid downhole. The density of the activation fluid is about 8 pounds per gallon (ppg) to about 20 ppg, specifically about 9 ppg to about 16 ppg, and more specifically about 10 ppg to about 15 ppg.

Without wishing to be bound by theory, it is believed that the activation fluid lowers the (original) glass transition temperature of the shape memory polymer through a plasticization process. The activation fluid includes low molecular weight compounds that are smaller than the polyurethane chains of the shape memory polymer; thus, the constituents of the activation fluid can penetrate and interact with the polyurethane polymer chain molecules, which may reduce the cohesive forces between the polymer chains. Consequently, the glass transition temperature is decreased from its original value due to an increase in the chain segment mobility. Once the activation fluid is removed or the concentration of the activation fluid begins to decrease, the Tg of the shape memory polymer increase towards its original value prior to contact with the activation fluid. Hence, the effect of the activation fluid on the Tg of the shape memory polymer can be temporary. Moreover, the glass transition temperature may not fully recover to its original value (before contact with activation fluid) but may instead be slightly lower than the original value of the glass transition temperature.

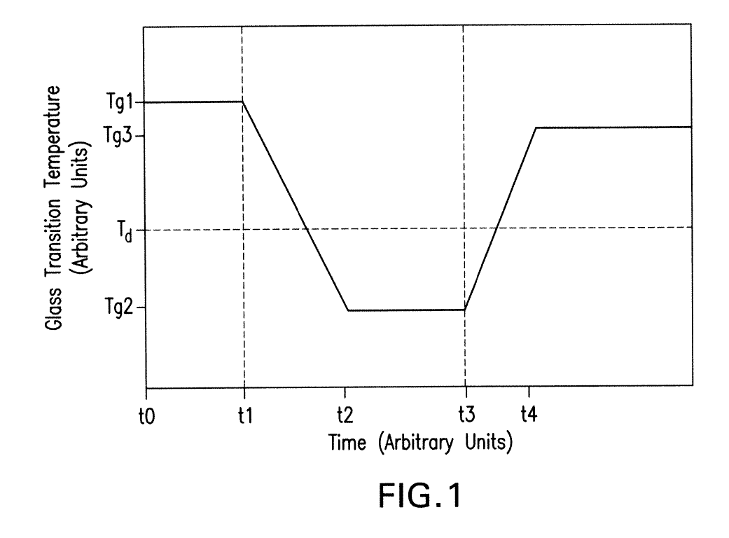

FIG. 1 shows variation of the glass transition temperature over time for a shape memory polymer. The shape memory polymer is initially in an environment at a first temperature Td, has a deformed shape at time t0, and has first glass transition temperature Tg1. The first glass transition temperature Tg1 is greater than the first temperature Td, i.e., Td<Tg1. It should be noted that with respect to FIG. 1, the first temperature Td is not changed although slight variations in Td can be expected. At time t1, an activation fluid contacts the shape memory polymer, and the glass transition temperature begins to decrease from the first glass transition temperature Tg1 until the shape memory polymer attains a second glass transition temperature Tg2 (at time t2), with Tg2<Td<Tg3. As the glass transition temperature decreases below Td, the shape memory polymer begins to actuate from its deformed shape to its original shape. At time t3, the activation fluid is displaced from the shape memory polymer, and the glass transition temperature begins to increase from the second glass transition temperature Tg2 to the third glass transition temperature T3. As the glass transition temperature becomes greater than Td, the original shape becomes fixed again in the shape memory polymer. At time t4 and greater, the shape memory polymer reaches its third glass transition temperature Tg3 and remains in the fixed original shape. As shown in FIG. 1, the third glass transition temperature Tg3 may be less than the first glass transition temperature Tg1. In an embodiment, the third glass transition temperature Tg3 is less than or equal to the first glass transition temperature Tg1.

Thus, the polyurethane shape memory polymer can recover its original shape upon contact with the activation fluid by virtue of a decrease in its transition glass temperature. Therefore, thermal activation of the shape memory effect can be avoided. Shape recovery by activation fluid described herein can significantly decrease the glass transition temperature of the polyurethane shape memory polymer. Instead of heating the shape memory polymer to a temperature greater than or about equal to its original Tg to actuate from the deformed shape to the original shape, shape recovery to the original shape can occur by contact with activation fluid to decrease the Tg of the polyurethane.

In an embodiment, the first glass transition temperature of the shape memory polymer is about 80° C. to about 160° C., specifically about 90 C.° to about 150° C., and more specifically about 100° C. to about 150° C. The second glass transition temperature is about 30° C. to about 120° C., specifically about 35° C. to about 110° C., and more specifically about 40° C. to about 100° C. The second glass transition temperature is about 5° C. to about 80° C., specifically about 10° C. to about 70° C., and more specifically about 10° C. to about 60° C. less than the first glass transition temperature. The third glass transition temperature is about 60° C. to about 160° C., specifically about 70° C. to about 165° C., and more specifically about 80° C. to about 150° C. Additionally, the first temperature (i.e., the temperature of the environment that the shape memory polymer is in) can be about 35° C. to about 110° C.

The shape memory polymers described herein can be used in diverse applications and are well-suited for downhole applications. The shape memory polymers can be initially molded into an original shape for use as, for example, a packer, a sandscreen, a blowout preventer element, a submersible pump motor protector bag, a sensor protector, a sucker rod, an O-ring, a T-ring, a gasket, a sucker rod seal, a pump shaft seal, a tube seal, a valve seal, a seal for an electrical component, an insulator for an electrical component, a seal for a drilling motor, a seal for a drilling bit, or other downhole elements. Before running the article downhole, the article is deformed above the Tg of the shape memory polymer, and fixed into the deformed shape upon cooling below the Tg.

In an embodiment, a method for deploying a shape memory polymer in a downhole environment includes disposing the shape memory polymer having a deformed shape in the downhole environment that is at a first temperature. The shape memory polymer can be a downhole element, e.g., a packer or sandscreen. The method further includes contacting the shape memory polymer with an activation fluid to decrease the glass transition temperature of the shape memory polymer below the first temperature; expanding the shape memory polymer to a deployed shape; and displacing the activation fluid to increase the glass transition temperature to greater than the first temperature and to maintain the shape memory polymer in the deployed shape. According to an embodiment, displacing the activation fluid includes replacing the activation fluid with a production fluid, which can be a fluid produced from the downhole environment such as a hydrocarbon, hydrocarbon-containing fluid, aqueous fluid, or a combination comprising at least one of the foregoing.

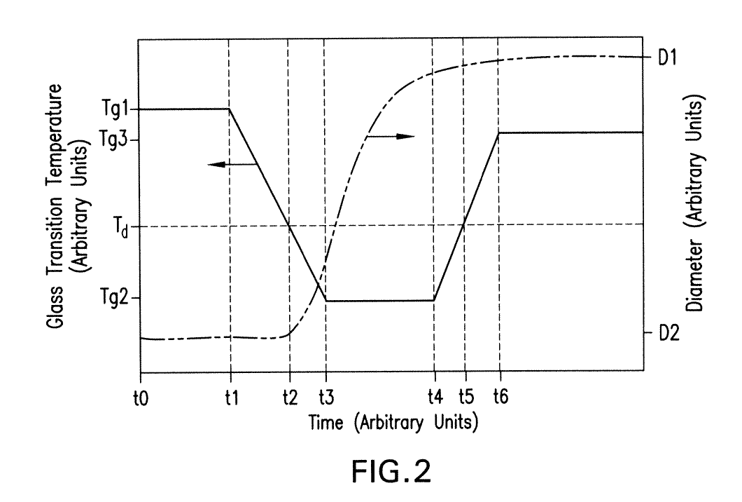

FIG. 2 shows the progression of downhole deployment of a shape memory polymer (SMP), e.g., a packer. The downhole environment (e.g., a borehole) has a temperature Td. The SMP in a deformed shape (with outer diameter D2) is disposed in the downhole environment at time t0. The SMP has a first glass transition temperature Tg1>Td. At time t1, the activation fluid contacts the SMP, and the glass transition temperature begins to decrease from Tg1. At time t2, the glass transition temperature of the SMP is about equal to Td so that the SMP begins to expand from the deformed shape, i.e., the diameter increases to a values greater than D2. At time t3, Tg1 has decreased to the second glass transition temperature Tg2, and the SMP continues to expand. At time t4, downhole fluids (e.g., hydrocarbons) are produced, and the activation fluid is displaced (or decreased) from the SMP so that the glass transition temperature begins to increase from Tg2 while expansion of the SMP continues (unless it has reached its original shape or has contacted the borehole wall or casing in the borehole). At time t5, the glass transition temperature of the SMP is about equal to Td, and expansion (if still occurring) of the SMP begins to decrease. At time t6, the SMP reaches its third glass transition temperature Tg3, and the SMP is fixed in the original shape, sealing the borehole if used a packer. By time t6, the SMP is deployed in the downhole environment. Although FIG. 2 shows Tg3<Tg1, the first glass transition temperature Tg1 can be equal to or greater than the third glass transition temperature Tg3. In other words, the final glass transition temperature can be less than or equal to the original glass transition temperature, and the intermediate glass transition temperature (Tg2 in FIG. 2) is less than both the original and final glass transition temperatures of the SMP. It will be appreciated that the glass transition temperature of the SMP is temporarily decreased below Td by the presence of the activation fluid, and the decrease of the glass transition temperature to the intermediate value (Tg2 in FIG. 2) is not permanent.

In an embodiment, the shape memory packer is deformed (for disposal downhole) to have a volume that is about 60% to about 5%, specifically about 50% to about 10%, and more specifically about 40% to about 20% less than the volume of the original shape. In another embodiment, the shape memory packer is deformed to have an outer diameter that is about 50% to about 5%, specifically about 40% to about 5%, and more specifically about 30% to about 5% less than outer diameter of the original shape.

In an embodiment, the shape memory polymer recovers 80% of its original size, specifically 90%, and more specifically 99% of its original size. As used herein, “size” of the shape memory polymer refers to a linear dimension of a working portion of the shape memory polymer. That is, if the shape memory polymer is used as a packer to seal a borehole, then the outer diameter is the working portion of the shape memory polymer, and the outer diameter would recover 80% of its original size, specifically 90%, and more specifically 99% of its original size.

According to a non-limiting embodiment, the rate of expansion of the shape memory polymer from the deformed shape to the original shape is about 0.3 millimeters per hour (mm/hr) to about 12 mm/hr, specifically about 0.4 mm/hr to about 10 mm/hr, and more specifically about 0.4 mm/hr to about 8 mm/hr.

The amount of the activation fluid used to lower the glass transition temperature below the downhole temperature depends on a number of factors such as the density and porosity of the shape memory polymer and downhole properties such as temperature and pressure. Therefore, the activation fluid is present in an amount effective to lower the transition glass temperature of the shape memory fluid below the downhole temperature. In one non-limiting embodiment, the activation fluid is pumped from the surface into the target zone to temporarily lower the transition glass temperature of the shape memory polymer to deploy the shape memory polymer to its original shape.

Thus, in an embodiment, a system for deploying a shape memory polymer includes an activation fluid comprising a brine, solvent, and alcohol; and a shape memory polymer which is deployed by a decrease in its glass transition temperature in response to contact with the activation fluid. In the system, the shape memory polymer can be an open cell foam including polyurethane, and the shape memory polymer actuates from a deformed shape to a deployed shape. Alternatively, the shape memory polymer is a solid including polyurethane and actuates from a deformed shape to a deployed shape.

The above embodiments are further demonstrated in the following examples, which are intended as illustrative only and are not intended to be limited thereto.

Deformed Shape Memory Polymer. A shape memory polymer (SMP) having open cell polyurethane foam was fabricated by combining MDI (isocyanate), polycarbonate polyol, and water in a mold and held at a temperature of 104° C. for 18 hours. The mold was cooled to room temperature, and the SMP was de-molded in an original shape. Subsequently, the SMP was placed in a cylinder and heated to 90° C. (a temperature above or close to the Tg of the SMP). The SMP was deformed by compressing the SMP between two plates in the cylinder to obtain a deformed shape having 25% of the volume of the original shape. The cylinder was cooled to room temperature, and the SMP removed from the cylinder to produce the SMP in the deformed shape.

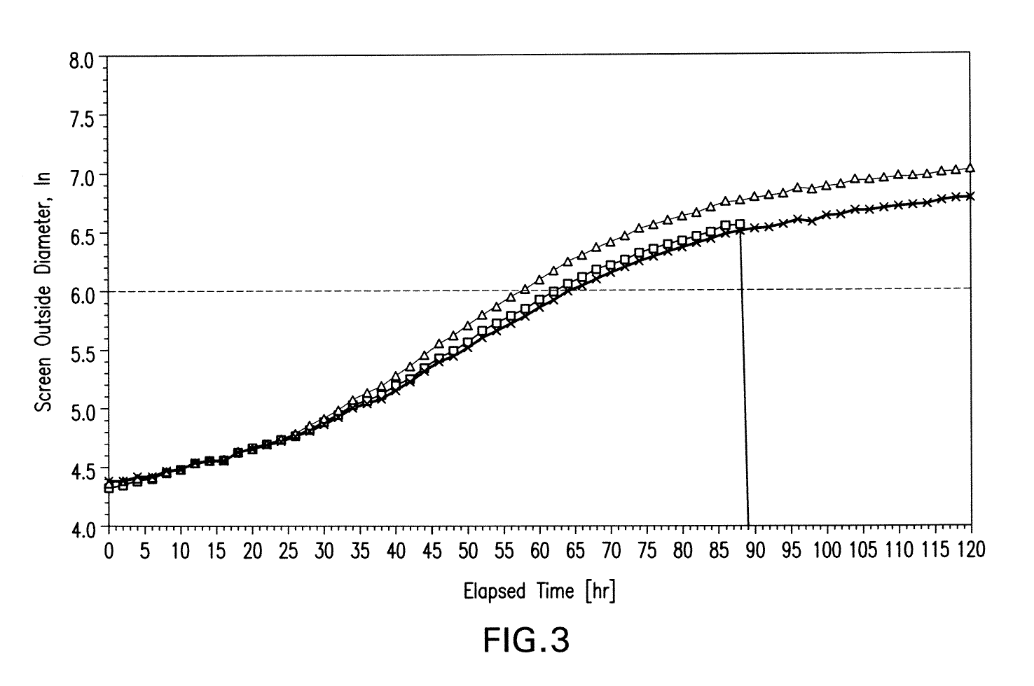

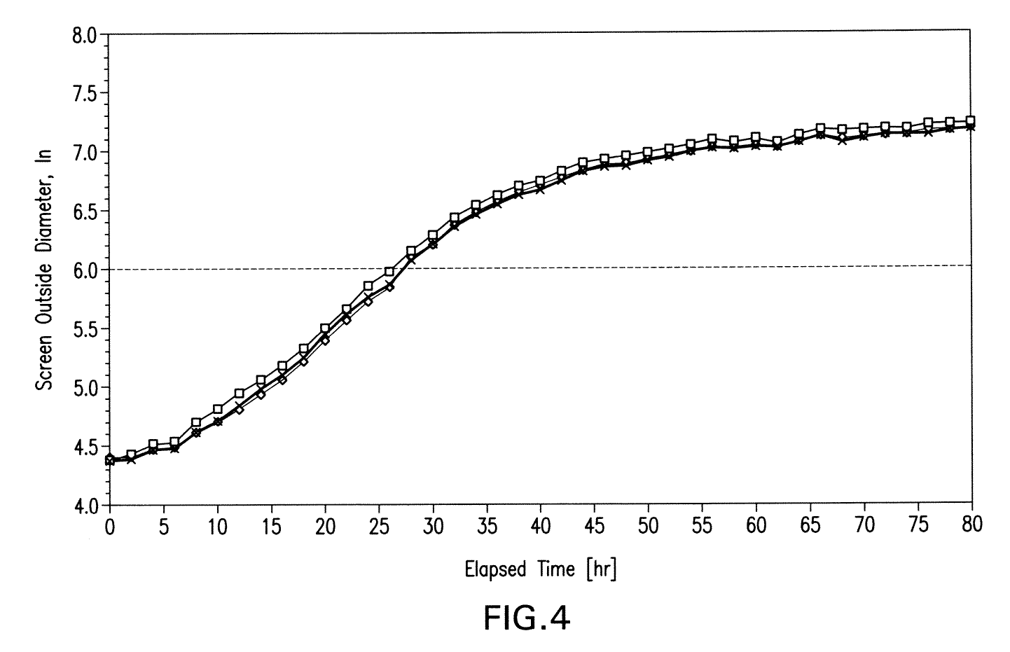

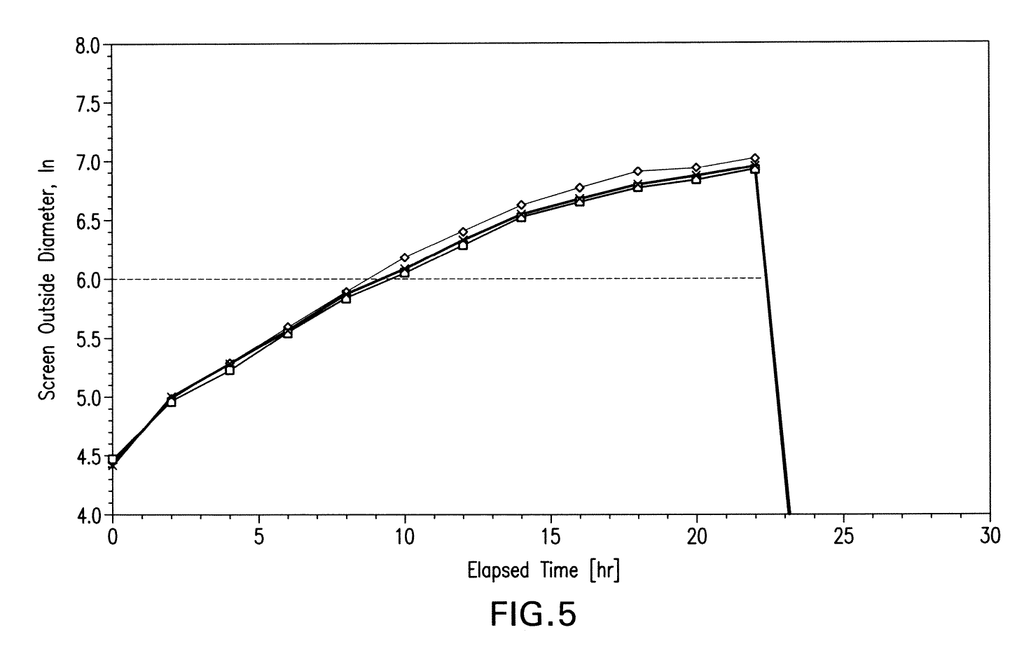

Shape Memory Recovery. The SMP in the deformed shape was placed in a container, and the container was filled with an activation fluid that included 65 volume percent (vol %) sodium bromide, 25 vol % methanol, and 10 vol % ethylene glycol monobutyl ether. The density of the activation fluid was 10.7 pounds per gallon (ppg). Data for the expansion of the SMP were acquired at temperatures of 105° F., 110° F., and 115° F. by placing a linear potentiometer on the top surface of the SMP and recording the expansion of the SMP by the displacement of the linear potentiometer as a function of time. FIG. 3 displays displacement data for an SMP at 105° F. Here, the height of the SMP versus the time is graphed, and the expansion of the SMP increases for greater than 115 hours. The expansion of three separate SMP samples was tested, and the data indicates that the measurements are highly reproducible. Therefore, the expansion of the SMP is well-defined and can be controlled. FIG. 4 shows data for SMP samples at a temperature of 110° F., and FIG. 5 shows data for SMP samples at a temperature of 115° F.

While one or more embodiments have been shown and described, modifications and substitutions may be made thereto without departing from the spirit and scope of the invention. Accordingly, it is to be understood that the present invention has been described by way of illustrations and not limitation.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. A method for deploying a shape memory polymer, comprising:
disposing a shape memory polymer having a deformed shape in an environment at a first temperature, the shape memory polymer having a first glass transition temperature which is greater than the first temperature;
decreasing the glass transition temperature of shape memory polymer from the first glass transition temperature to a second glass transition temperature which is less than or equal to the first temperature; and
expanding the shape memory polymer to deploy the shape memory polymer in a deployed shape.

2. The method of claim 1, wherein the shape memory polymer includes polyurethane.

3. The method of claim 1, wherein the shape memory polymer is an open cell foam.

4. The method of claim 1, wherein decreasing the glass transition temperature of the shape memory polymer comprises contacting the shape memory polymer with an activation fluid.

5. The method of claim 4, wherein the activation fluid comprises a brine, solvent, and alcohol.

6. The method of claim 5, wherein the brine comprises seawater, produced water, completion brine, or a combination thereof

7. The method of claim 6, wherein the brine further comprises NaCl, KCl, NaBr, MgCl₂, CaCl₂, CaBr₂, ZnBr₂, NH₄Cl, sodium formate, potassium formate, cesium formate, or a combination comprising at least one of the foregoing.

8. The method of claim 5, wherein the solvent includes a substituted glycol, unsubstituted glycol, amide, or a combination comprising at least one of the foregoing.

9. The method of claim 8, wherein the solvent is a substituted glycol comprising ethylene glycol monomethyl ether, ethylene glycol monoethyl ether, ethylene glycol monopropyl ether, ethylene glycol monoisopropyl ether, ethylene glycol monobutyl ether, ethylene glycol monophenyl ether, ethylene glycol monobenzyl ether, diethylene glycol monomethyl ether, diethylene glycol monoethyl ether, diethylene glycol mono-n-butyl ether, dipropylene glycol monomethyl ether, ethylene glycol dimethyl ether, ethylene glycol diethyl ether, ethylene glycol dibutyl ether, ethylene glycol methyl ether acetate, ethylene glycol monethyl ether acetate, ethylene glycol monobutyl ether acetate, or a combination comprising at least one of the foregoing.

10. The method of claim 8, wherein the solvent is a glycol comprising ethylene glycol, propylene glycol butylene glycol, hexylene glycol, dipropylene glycol, diethylene glycol, tripropylene glycol, triethylene glycol, or a combination comprising at least one of the foregoing.

11. The method of claim 8, wherein the amide is N,N-dimethylformamide, N,N-diethylformamide, N,N-dimethylacetamide, N,N-diethylacetamide, N,N-dimethylpropionamide, N,N-dimethylbutyramide, 1-methyl-2-pyrrolidinone, 1-ethyl-2-pyrrolidinone, or a combination comprising at least one of the foregoing.

12. The method of claim 5, wherein the alcohol includes methanol, ethanol, n-propanol, isopropanol, n-butanol, 2-butanol, isobutanol, tert-butanol, n-pentanol, isopentanol, 2-pentanol, hexanol, octanol, isooctanol, cyclohexanol, 2-methyl-1-butanol, 2-methyl-1-pentanol, 3-methyl-2-butanol, 2-ethylhexanol, or a combination comprising at least one of the foregoing.

13. The method of claim 1, wherein the first glass transition temperature is about 100° C. to about 150° C.

14. The method of claim 1, wherein the second glass transition temperature is about 40° C. to about 100° C.

15. The method of claim 1, wherein the second glass transition temperature is about 10° C. to about 60° C. less than the first glass transition temperature.

16. The method of claim 1, wherein the first temperature is about 60° C. to about 100° C.

17. The method of claim 1, further comprising, after expanding the shape memory polymer, increasing the glass transition temperature of the shape memory polymer to a third glass transition which is greater than the second glass transition temperature.

18. The method of claim 17, wherein the third glass transition temperature is less than or equal to the first glass transition temperature, and greater than the first temperature such that shape memory polymer maintains the deployed shape.

19. The method of claim 17, wherein the third glass transition temperature is about 80° C. to about 150° C.

20. A method for deploying a shape memory polymer in a downhole environment, comprising:
disposing a shape memory polymer having a deformed shape in the downhole environment which is at a first temperature;
contacting the shape memory polymer with an activation fluid to decrease the glass transition temperature of the shape memory polymer below the first temperature;
expanding the shape memory polymer to a deployed shape; and
displacing the activation fluid to increase the glass transition temperature to greater than the first temperature and to maintain the shape memory polymer in the deployed shape.

21. The method of claim 20, wherein, the activation fluid comprises a brine, solvent, and alcohol.

22. The method of claim 21, wherein the shape memory polymer is an open cell foam comprising polyurethane.

23. The method of claim 20, wherein displacing the activation fluid comprises replacing the activation fluid with a production fluid.

24. The method of claim 23, wherein the production fluid includes a hydrocarbon produced from the downhole environment.

25. A system for deploying a shape memory polymer, comprising:
an activation fluid comprising a brine, solvent, and alcohol; and
a shape memory polymer which is deployed by a decrease in its glass transition temperature in response to contact with the activation fluid.

26. The system of claim 24, wherein the shape memory polymer is an open cell foam including polyurethane; and the shape memory polymer actuates from a deformed shape to a deployed shape.
